(19) United States
(12) Patent Application Publication
(10) Pub. No.: US 2020/0051228 A1
(43) Pub. Date: Feb. 13, 2020

(54) Face Deblurring Method and Device

(71) Applicant: Suzhou Keda Technology Co., Ltd., Jiangsu (CN)

(72) Inventors: Zhaolong Jin, Jiangsu (CN); Guozhong Wang, Jiangsu (CN); Weidong Chen, Jiangsu (CN)

(21) Appl. No.: 16/654,779

(22) Filed: Oct. 16, 2019

Related U.S. Application Data
(63) Continuation of application No. PCT/CN2017/117166, filed on Dec. 19, 2017.

(30) Foreign Application Priority Data
Aug. 31, 2017 (CN) 201710774351.1

(51) Int. Cl. G06T 5/50; G06T 17/00; G06T 5/00

(52) U.S. Cl. CPC G06T 5/50; G06T 17/00; G06T 2200/04; G06T 2207/30201; G06T 5/003

(57) ABSTRACT

A face blurring method comprises: acquiring a face image to be processed; aligning the face image onto a face mask, and performing grid division on the same; matching each grid of the divided face image with a grid of a first grid dictionary, obtaining blurred grids corresponding to each grid of the face image, the first grid dictionary obtained by dividing a first two-dimensional image library according to the face mask after alignment; according to the blurred grids, querying in a second grid dictionary a plurality of clear grids corresponding to the blurred grids on a one to one basis, the second grid dictionary obtained after dividing a second two-dimensional image library according to the face mask alignment, and the blurred images correspond to the clear images on a one to one basis; and according to the queried clear grids, generating a clear image of the face image.

### CROSS REFERENCE TO RELATED APPLICATIONS

This application is a continuation of International Application No. PCT/CN2017/117166, filed on Dec. 19, 2017, which is based upon and claims priority to Chinese Patent Application No. 201710774351.1, filed on Aug. 31, 2017, the entire contents of which are incorporated herein by reference.

### TECHNICAL FIELD

The present application relates to the field of image processing technology, specifically to a face deblurring method and device.

### BACKGROUND

During the capturing of face images, as a typical phenomenon, the captured image tends to have brightness imbalance or blurring, which will have a great impact on image quality. Particularly, with the popularization of intelligent terminals and handheld devices without stabilizers, it has become more and more common for images and videos photographed to contain blurry parts. There are many factors affecting the clarity of the images, such as jitters, inaccurate focus, overexposure or uneven exposure, and relative movement between the camera and the scene during the shooting, all of which bring down the quality of the image, a process also referred to as image degradation.

However, the poor quality of the image will bring great inconvenience to public security officers and criminal investigators, because during tracking and identification of suspects in handling a case, the criminal investigators rely heavily on manual screening of monitoring videos at various spots, or employ a facial recognition system for face comparison. However, the video surveillance construction at various spots is often at different stages, leading to the shortage of scenes in some places, and poor image quality somewhere else, for example, in some cases of video surveillance, there are problems of coverage, blurs or overdue postures during face imaging.

Therefore, in prior art, in order to solve the above technical problem, the blurred region is first extracted from a face image to be processed, and then processed by relative algorithms to recover an implicit clear image from the blurred image.

However, in the above technical solution, it is necessary to detect the blurred region contained in the blurred image as accurately as possible, and then restore the clear image corresponding to the blurred region from the blurred image itself, resulting in poor effect of the deblurring method.

### SUMMARY

To this end, embodiments of the present invention provide a face deblurring method and device, so as to solve the problem of poor deblurring effect of a face image in the prior art.

A first aspect of the present invention provides a face deblurring method, comprising the following steps:

acquiring a face image to be processed;

aligning the face image to be processed onto a face mask, and performing grid division on the same;

matching each grid of the divided face image to be processed with a grid of a first grid dictionary, so as to obtain a plurality of blurred grids corresponding to each grid of the face image to be processed, wherein the first grid dictionary is obtained by dividing a first two-dimensional image library according to the face mask after alignment, and the first two-dimensional image library is a two-dimensional image library of blurred images constructed using a first three-dimensional image library obtained via a three-dimensional reconstruction method;

querying in a second grid dictionary a plurality of clear grids corresponding to the plurality of blurred grids on a one to one basis, according to the blurred grids, wherein the second grid dictionary is obtained by dividing a second two-dimensional image library according to the face mask after alignment, the second two-dimensional image library is a two-dimensional image library of clear images constructed using a second three-dimensional image library obtained via the three-dimensional reconstruction method, and the blurred images correspond to the clear images on a one to one basis; and

generating a clear image of the face image to be processed according to the queried clear grids.

Optionally, matching each grid of the divided face image to be processed with a grid of a first grid dictionary so as to obtain a plurality of blurred grids corresponding to each grid of the face image to be processed comprises the following steps:

acquiring pixels of each grid of the face image to be processed and each grid of the first grid dictionary, respectively;

calculating an Euclidean distance of pixels between each grid of the face image to be processed and each grid of the first grid dictionary, respectively, according to the acquired pixels; and

acquiring M blurred grids matched with each grid of the face image to be processed according to the calculated Euclidean distance.

Optionally, querying in a second grid dictionary a plurality of clear grids corresponding to the plurality of blurred grids on a one to one basis, according to the blurred grids, comprises the following steps:

acquiring coordinates of the blurred grids on the face mask; and

querying the clear grids corresponding with the blurred grids in the second grid dictionary according to the coordinates.

Optionally, deblurring grids of the face image to be processed according to the clear grids comprises the following steps:

acquiring pixels of the clear grids; and

processing grids of the face image to be processed, so that the pixels of each grid of the face image to be processed is the sum of the pixels of the plurality of clear grids.

Optionally, the face deblurring method comprises the following steps before acquiring the face image to be processed:

acquiring the first three-dimensional image library and the second three-dimensional image library obtained via the three-dimensional reconstruction method, and the first three-dimensional image library and the second three-dimensional image library are respectively a two-dimensional cylindrical exploded view of several blurred images and corresponding clear images;

allocating posture parameters of the face image to be processed; and

constructing the corresponding first two-dimensional image library and second two-dimensional image library in the first three-dimensional image library and the second three-dimensional image library respectively, according to the posture parameters.

Optionally, the posture parameters are angles (θₓ, θ_{y}, θ_{z}) of the face image to be processed in three-dimensional space;

wherein, θₓ is an offset angle of the face image to be processed in an x direction, θ_{y} is an offset angle of the face image to be processed in a y direction, and θ_{z} is an offset angle of the face image to be processed in a z direction.

A second aspect of the present invention provides a face deblurring device, comprising:

a first acquisition unit, for acquiring a face image to be processed;

a division unit, for aligning the face image to be processed onto a face mask, and performing grid division on the same;

a matching unit, for matching each grid of the divided face image to be processed with a grid of a first grid dictionary, so as to obtain a plurality of blurred grids corresponding to each grid of the face image to be processed, wherein the first grid dictionary is obtained by dividing a first two-dimensional image library according to the face mask after alignment, and the first two-dimensional image library is a two-dimensional image library of blurred images constructed using a first three-dimensional image library obtained via a three-dimensional reconstruction method;

a querying unit, for querying in a second grid dictionary a plurality of clear grids corresponding to the plurality of blurred grids on a one to one basis, according to the blurred grids, wherein the second grid dictionary is obtained by dividing a second two-dimensional image library according to the face mask after alignment, the second two-dimensional image library is a two-dimensional image library of clear images constructed using a second three-dimensional image library obtained via the three-dimensional reconstruction method, and the blurred images correspond to the clear images on a one to one basis; and

a processing unit, for generating a clear image of the face image to be processed according to the queried clear grids.

Optionally, the matching unit comprises:

a second acquisition unit, for acquiring pixels of each grid of the face image to be processed and each grid of the first grid dictionary, respectively;

a calculation unit, for calculating an Euclidean distance of pixels between each grid of the face image to be processed and each grid of the first grid dictionary, respectively, according to the acquired pixels; and

a third acquisition unit, for acquiring M blurred grids matched with each grid of the face image to be processed according to the calculated Euclidean distance.

A third aspect of the present invention provides an image processing device, comprising at least one processor; and memory in communication connection with the at least one processor; wherein, the memory stores instructions executable by the one processor, and the instructions are executed by the at least one processor, so that the at least one processor executes the face deblurring method in any manner of the first aspect of the present invention.

A fourth aspect of the present invention provides a non-transient computer readable storage medium which stores computer instruction used to allow a computer to execute the face deblurring method in the first aspect or any optional manner of the first aspect.

A fifth aspect of the present invention provides a computer program product, comprising computer program stored on the non-transient computer readable storage medium; the computer program comprises program instructions, which, when executed by the computer, allows the computer to execute the face deblurring in the first aspect or any optional manner of the first aspect.

The technical solutions provided by the present invention have the following advantages.

The face deblurring method provided by the embodiments of the present invention comprises the following steps: acquiring a face image to be processed; aligning the face image to be processed onto a face mask, and performing grid division on the same; matching each grid of the divided face image to be processed with a grid of a first grid dictionary, so as to obtain a plurality of blurred grids corresponding to each grid of the face image to be processed, wherein the first grid dictionary is obtained by dividing a first two-dimensional image library according to the face mask after alignment, and the first two-dimensional image library is a two-dimensional image library of blurred images constructed using a first three-dimensional image library obtained via a three-dimensional reconstruction method; querying in a second grid dictionary a plurality of clear grids corresponding to the plurality of blurred grids on a one to one basis, according to the blurred grids, wherein the second grid dictionary is obtained by dividing a second two-dimensional image library according to the face mask after alignment, the second two-dimensional image library is a two-dimensional image library of clear images constructed using a second three-dimensional image library obtained via the three-dimensional reconstruction method, and the blurred images correspond to the clear images on a one to one basis; and generating a clear image of the face image to be processed according to the queried clear grids. The face deblurring method provided by the embodiments of the present invention is capable of processing face images with different postures with good face deblurring effect.

In the face deblurring method provided by the embodiments of the present invention, wherein, deblurring grids of the face image to be processed according to the clear grids comprises the following steps: acquiring pixels of the clear grids; and processing grids of the face image to be processed, so that the pixels of each grid of the face image to be processed is the sum of the pixels of the plurality of clear grids. In the embodiments of the present invention, during the process of replacing the blurred grids with the clear grids, with respect to the grid pixels at fixed positions, the grid pixels obtained by weighting of grid pixels at the same position of a face with different clarities are chosen to replace the blurred grid pixels, which brings about good face deblurring effect.

The face deblurring method provided by the embodiments of the present invention comprises the following steps before acquiring the face image to be processed: acquiring the first three-dimensional image library and the second three-dimensional image library obtained via the three-dimensional reconstruction method, and the first three-dimensional image library and the second three-dimensional image library are respectively a two-dimensional cylindrical exploded view of several blurred images and corresponding clear images; allocating posture parameters of the face image to be processed; and constructing the corresponding first two-dimensional image library and second two-dimensional image library in the first three-dimensional image library and the second three-dimensional image library respectively, according to the posture parameters. The face deblurring method provided by the embodiments of the present invention is able to set posture parameters of the face image to be processed in the space according to a user, so as to acquire a two-dimensional image dictionary under corresponding posture parameters from a histogram dictionary, and is thus able to perform face deblurring with certain postures in a video surveillance scene.

The face deblurring device provided by this embodiment comprises: a first acquisition unit, for acquiring a face image to be processed; a division unit, for aligning the face image to be processed onto a face mask, and performing grid division on the same; a matching unit, for matching each grid of the divided face image to be processed with a grid of a first grid dictionary, so as to obtain a plurality of blurred grids corresponding to each grid of the face image to be processed, wherein the first grid dictionary is obtained by dividing a first two-dimensional image library according to the face mask after alignment, and the first two-dimensional image library is a two-dimensional image library of blurred images constructed using a first three-dimensional image library obtained via a three-dimensional reconstruction method; a querying unit, for querying in a second grid dictionary a plurality of clear grids corresponding to the plurality of blurred grids on a one to one basis, according to the blurred grids, wherein the second grid dictionary is obtained by dividing a second two-dimensional image library according to the face mask after alignment, the second two-dimensional image library is a two-dimensional image library of clear images constructed using a second three-dimensional image library obtained via the three-dimensional reconstruction method, and the blurred images correspond to the clear images on a one to one basis; and a processing unit, for generating a clear image of the face image to be processed according to the queried clear grids. The face deblurring device provided by embodiments of the present invention is able to process face images with different postures, delivering good face deblurring effect.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

The features and advantages of the present invention will be understood more clearly in conjunction with the drawings, and the drawings are illustrative rather than restricted on the present invention, in the drawings:

FIG. 1 shows a diagram where a face facing the front turns to other postures during three-dimensional face reconstruction;

FIG. 2 shows a three-dimensional shape model of a face;

FIG. 3 shows a two-dimensional cylindrical exploded view with three-dimensional face texture;

FIG. 4 shows a specifically illustrated flowchart of a face deblurring method in embodiment 1 of the present invention;

FIG. 5 shows a specifically illustrated flowchart of a face deblurring method in embodiment 2 of the present invention;

FIG. 6 shows a specifically illustrated flowchart of a face deblurring method in embodiment 3 of the present invention;

FIG. 7 shows a specifically illustrated structural diagram of a face deblurring method in embodiment 4 of the present invention;

FIG. 8 shows another specifically illustrated structural diagram of a face deblurring method in embodiment 4 of the present invention;

FIG. 9 shows a specifically illustrated structural diagram of a face deblurring method in embodiment 5 of the present invention.

### DETAILED DESCRIPTION

In order to make the purpose, technical solutions and advantages in embodiments of the present invention clearer, the technical solutions in the embodiments of the present invention will be described as follows clearly and completely referring to figures accompanying the embodiments of the present invention, and certainly, the described embodiments are just part rather than all embodiments of the present invention. Based on the embodiments of the present invention, all the other embodiments acquired by those skilled in the art without delivering creative efforts shall fall into the protection scope of the present invention.

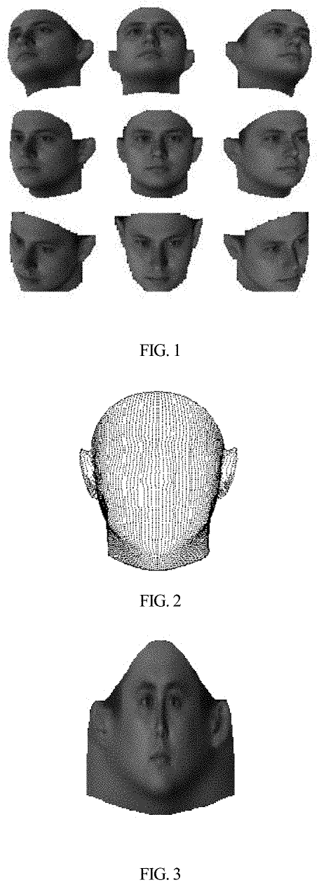

In the embodiments of the present invention, the three-dimensional face reconstruction is performed by turning a frontal face image to a face image with any other angles using a three-dimensional face model, specifically shown as FIG. 1, i.e., a face image with corresponding postures can be obtained for a frontal face image as long as posture parameters are given. The three-dimensional face model comprises information in the following four aspects:

a three-dimensional shape of a frontal face S=(x₁, y₁, z₁, . . . , xₙ, yₙ, zₙ)^{T} wherein n indicates the number of shape vertexes;

three-dimensional texture of a frontal face T=(r₁, g₁, b₁, . . . , rₘ, gₘ, bₘ)^{T}, wherein m indicates the number of pixels of a texture image;

the correspondence of the shape vertexes of the frontal face to the texture image, that is, each shape point of the two-dimensional shape can correspond to a texture pixel value, as shown by the three-dimensional shape model of a demonstrative face in FIG. 2;

pixel values of other shape points that are not in the model are obtained by pixel interpolation of surrounding shape vertexes in the model.

For any two-dimensional frontal face image, the process of reconstructing a face with any angle from a frontal face is as follows:

Step 1: using ASM to locate 68 face key points;

Step 2: aligning the current face two-dimensional shape onto the three-dimensional shape of the model using the 68 key points, because the rotation angle in the Z direction is 0 for the frontal face, parameters (θₓ, θ_{y}, θ_{z}, Δx, Δy, Δz, s) are needed, wherein, θₓ, θ_{y}, θ_{z} respectively indicate rotation angles in the x, y, z directions, Δx, Δy, Δz respectively indicate translations in the x, y, z directions, and s indicates a zoom factor;

Step 3: performing rotation, translation and zooming to each vertex of the above shape S using the rotation, translation and zoom parameters calculated in Step 2, i.e., aligning the current shape onto a standard shape in the model;

Step 4: finally obtaining the two-dimensional cylindrical exploded view of a complete three-dimensional face texture diagram as shown in FIG. 3 using the information in Step (2) and Step (3) combining the Kriging interpolation;

Step 5: when a user inputs rotation angle parameter (θₓ, θ_{y}, θ_{z}) of a current frontal face, rotating the shape vertexes after alignment (a reverse process of Step 2); and

Step 6: according to the parameters calculated in Step 5, obtaining a target image via Kriging interpolation combining the two-dimensional cylindrical exploded view of the three-dimensional face texture diagram generated in Step 4.

It only needs to construct a three-dimensional texture image library of multiple faces when three-dimensional face reconstruction is introduced to perform face processing of any postures. When setting the posture parameters, a customer can perform variation to obtain a two-dimensional texture image library of this posture, and online training of different face processing models using the two-dimensional texture image library can allow different image processing of any posture.

### Embodiment 1

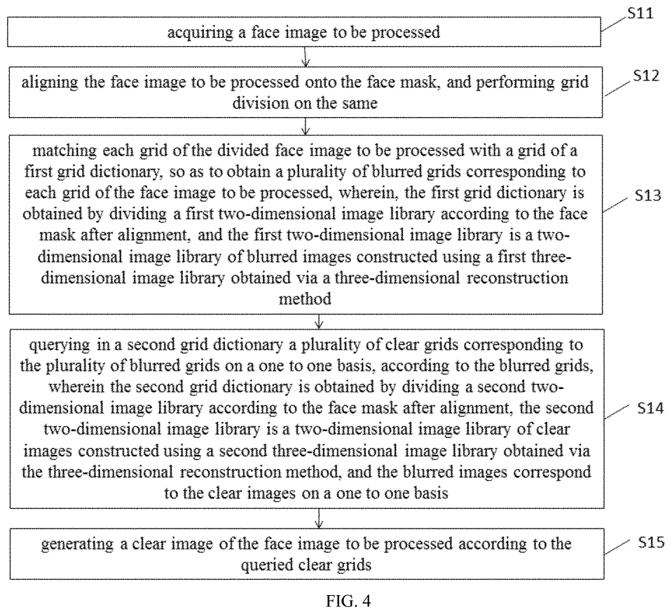

This embodiment provides a face deblurring method used in a face deblurring device. As shown in FIG. 4, the face deblurring method comprises the following steps:

Step S11, acquiring a face image to be processed.

The face image in this embodiment can be an image stored in a face deblurring device in advance, or an image acquired by the face deblurring device from the outside in real time, or an image extracted by the face deblurring device from a video.

Step S12, aligning the face image to be processed onto the face mask, and performing grid division on the same.

Because the face have a relatively fixed structure, such as eyebrows, eyes, nose, mouth, which have little difference if taken alone, and the difference is much more minute, if the organs are divided into many textures and pieces. Based on this, a face image is divided into small grids, and each organ is composed of a plurality of grids in the embodiments of the present invention.

The face mask in this embodiment serves as a reference for dividing the face image to be processed. When performing grid division to the face image to be processed, the face image to be processed is subjected to alignment of five facial organs and size normalization, i.e., the eyes, eyebrows, nose, and mouth are generally at the same position as the corresponding organs of the face mask, thus ensuring the standardization and accuracy of the division.

In this embodiment, the face image to be processed can be divided into grids of m rows and n columns, where m is the number of grids in the vertical direction, and n is the number of grids in the horizontal direction. The specific value of m and n can be set according to the accuracy of the face image to be processed after the actual processing, and can be equal or unequal.

Step S13, matching each grid of the divided face image to be processed with a grid of a first grid dictionary, so as to obtain a plurality of blurred grids corresponding to each grid of the face image to be processed, wherein, the first grid dictionary is obtained by dividing a first two-dimensional image library according to the face mask after alignment, and the first two-dimensional image library is a two-dimensional image library of blurred images constructed using a first three-dimensional image library obtained via a three-dimensional reconstruction method.

In this embodiment, the first three-dimensional image library is a face dictionary library of blurred images of S faces, i.e., the above three-dimensional face reconstruction method is used to obtain a two-dimensional cylindrical exploded view of corresponding blurred images; and a first two-dimensional image library can be extracted from the two-dimensional cylindrical exploded view according to a deflection angle of the face image to be processed relative to a frontal image. The first grid dictionary is obtained by dividing the first two-dimensional image library according to the face mask after alignment; wherein, the blurred images of S faces are subjected to alignment of five facial organs and size normalization, i.e., the eyes, eyebrows, nose, and mouth of each face are generally at the same position in the image, so that the grids of the first grid dictionary have the same coordinates as the grids of the face image to be processed at corresponding positions on the face mask.

In this embodiment, it improves the matching accuracy, thus the resolution of the face image to be processed after the processing, by matching the plurality of blurred grids of the first grid dictionary with one grid of the face image to be processed.

Step S14, querying in a second grid dictionary a plurality of clear grids corresponding to the plurality of blurred grids on a one to one basis, according to the blurred grids, wherein the second grid dictionary is obtained by dividing a second two-dimensional image library according to the face mask after alignment, the second two-dimensional image library is a two-dimensional image library of clear images constructed using a second three-dimensional image library obtained via the three-dimensional reconstruction method, and the blurred images correspond to the clear images on a one to one basis.

In this embodiment, the second three-dimensional image library is a face dictionary library of clear images of S faces, i.e., a two-dimensional cylindrical exploded view of corresponding clear images are obtained using the above three-dimensional face reconstruction method; a second two-dimensional image library may be extracted from the two-dimensional cylindrical exploded view according to the deflection angle of the face image to be processed relative to the frontal image. The second grid dictionary is obtained by dividing a second two-dimensional image library according to the face mask after alignment, i.e., the grids of the first grid dictionary, the second grid dictionary and the face image to be processed at corresponding positions have the same coordinates on the face mask.

With the same coordinates at corresponding positions of the three, it is convenient to query in the second grid dictionary a plurality of clear grids corresponding to the plurality of blurred grids on a one to one basis.

It should be noted that, in the embodiment of the present invention, the blurred image, clear image and the blurred grids and clear grids mentioned below are relative terms, for example, the clear image indicates an image capable of being quickly recognized by the human eye, which can be specifically defined by some image parameters (for example, pixels), and this also applies to a blurred image.

Step S15, generating a clear image of the face image to be processed according to the queried clear grids.

In this embodiment, the queried clear grids may be used to directly replace the grids in the face image to be processed, alternatively, pixels of the queried clear grids after processing may be used to replace the grid pixels of the face image to be processed.

### Embodiment 2

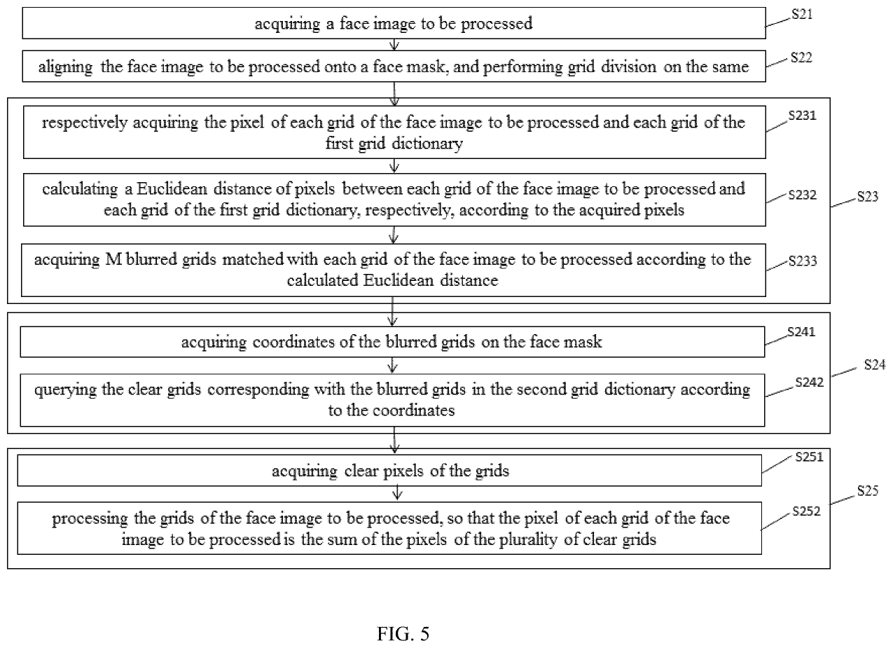

This embodiment provides a face deblurring method used in a face deblurring device. As shown in FIG. 5, the face deblurring method comprises the following steps:

Step S21, acquiring a face image to be processed. This step is the same as Step S11 in embodiment 1 and will not be repeated.

Step S22, aligning the face image to be processed onto a face mask, and performing grid division on the same. The step is the same as Step S12 in embodiment 1, and will not be repeated.

Step S23, matching each grid of the divided face image to be processed with a grid of a first grid dictionary, so as to obtain a plurality of blurred grids corresponding to each grid of the face image to be processed, wherein the first grid dictionary is obtained by dividing a first two-dimensional image library according to the face mask after alignment, and the first two-dimensional image library is a two-dimensional image library of blurred images constructed using a first three-dimensional image library obtained via a three-dimensional reconstruction method.

In this embodiment, a Euclidean distance of pixels between the grid of the face image to be processed and the grid of the first grid dictionary is calculated, and grids in the first grid dictionary are located to match with the grids of the face image to be processed according to the Euclidean distance.

In an alternative implementation of this embodiment, Step S23 specifically comprises the following steps:

Step S231, respectively acquiring the pixel of each grid of the face image to be processed and each grid of the first grid dictionary.

In this embodiment, the pixel of the grid of the face image to be processed and the pixel of the grid of a first grid dictionary may be obtained by summing up and averaging the value of all pixels of each grid; furthermore, with alignment onto the face mask for grid division, the face image to be processed and the first grid dictionary have the same number of divided grids, which is indicated as N; each grid has the same number of pixels, allowing the use of a pixel vector composed of all pixels in the grid to indicate the pixel of the grid, that is, the pixel of the grid of the face image to be processed is annotated as \vec{y}ₜ, wherein, t is a t^{th} grid of the face image to be processed, t=1 to N; the pixel of the grid of the first grid dictionary is annotated as \vec{y}ᵢ, wherein, I is an i^{th} grid in the first grid dictionary, and i=1 to N.

In an alternative implementation of this embodiment, the pixel of the grid of the face image to be processed and the pixel of the grid of the first grid dictionary are indicated with a pixel vector composed of all pixels in the grid.

Step S232, calculating an Euclidean distance of pixels between each grid of the face image to be processed and each grid of the first grid dictionary, respectively, according to the acquired pixels.

In this embodiment, an Euclidean distance of pixels between each grid of the face image to be processed and each grid of the first grid dictionary is calculated, the calculated distances are ranked, and M grids in the first grid dictionary with the smallest distances are screened out, i.e., M blurred grids in the first grid dictionary corresponding to each grid of the face image to be processed are screened out. The value of M can be an arbitrary value between 10-20. In an alternative implementation of this embodiment, M=10, which can simplify the calculation while ensuring precise screening effect. The Euclidean distance can be calculated with the following formula:

distᵢ=∥\vec{y}ₜ−\vec{y}ᵢ∥;

wherein, \vec{y}ₜ is a t^{th} pixel of the grid of the face image to be processed, \vec{y}ᵢ is an i^{th} pixel of the grid of the first grid dictionary.

In this embodiment, the number of the grids of the face image to be processed is the same as the grids of the first grid dictionary, during calculation, when calculation is performed from t=1 to t=N, the corresponding Euclidean distance is:

when t=1, calculating distᵢ=∥\vec{y}₁−\vec{y}ᵢ∥, i=1 to N; wherein, \vec{y}₁ is a first pixel of the grid of the face image to be processed;

when t=2, calculating distᵢ=∥\vec{y}₂−\vec{y}ᵢ∥, i=1 to N; wherein, \vec{y}₂ is a second pixel of the grid of the face image to be processed;

when t=N, calculating distᵢ=∥\vec{y}_{N}−\vec{y}ᵢ∥, i=1 to N; wherein, \vec{y}_{N} is an N^{th} pixel of the grid of the face image to be processed.

Step S233, acquiring M blurred grids matched with each grid of the face image to be processed according to the calculated Euclidean distance.

In an alternative implementation of this embodiment, after calculating the Euclidean distance of pixels between each grid of the face image to be processed and each grid of the first grid dictionary, taking a reciprocal of the distance and ranking, and screening out M grids of the first grid dictionary with the greatest reciprocals.

In an alternative implementation of this embodiment, after calculating the Euclidean distance of pixels between each grid of the face image to be processed and each grid of the first grid dictionary, a reciprocal of the distance is calculated, a constant A is subtracted by the reciprocal and then ranked, and M grids of the first grid dictionary with the greatest subtraction result are screened out. In this embodiment, A=1, which can simplify the calculation while improving the deblurring accuracy of the face image.

Step S24, querying in a second grid dictionary a plurality of clear grids corresponding to the plurality of blurred grids on a one to one basis, according to the blurred grids, wherein the second grid dictionary is obtained by dividing a second two-dimensional image library according to the face mask after alignment, the second two-dimensional image library is a two-dimensional image library of clear images constructed using a second three-dimensional image library obtained via the three-dimensional reconstruction method, and the blurred images correspond to the clear images on a one to one basis.

In this embodiment, the grids of the first grid dictionary, the second grid dictionary and the face image to be processed at corresponding positions have the same coordinates on the face mask. As a result, in the first grid dictionary, after querying a plurality of blurred grids corresponding to the grids of the face image to be processed, querying may be performed in a second grid dictionary for a plurality of clear grids corresponding to the plurality of blurred grids on a one to one basis, according to the coordinates of the plurality of blurred grids.

In an alternative implementation of this embodiment, Step S24 specifically comprises the following steps:

Step S241, acquiring coordinates of the blurred grids on the face mask.

In this embodiment, each grid of the face image to be processed has M matched blurred grids in the first dictionary, and positions of the blurred grids on the face mask can be determined by sequentially acquiring coordinates of the M blurred grids on the face mask.

Step S242, querying the clear grids corresponding with the blurred grids in the second grid dictionary according to the coordinates.

In this embodiment, the grids of the first grid dictionary, the second grid dictionary and the face image to be processed at corresponding positions have the same coordinates on the face mask. As a result, the coordinates of the plurality of blurred grids corresponding to those of the plurality of clear grids in the second grid dictionary, thus the plurality of clear grids can be determined according to the coordinates.

Step S25, performing deblurring to the grids of the face image to be processed according to clear grids.

In this embodiment, after querying M clear grids corresponding to each grid of the face image to be processed in the second grid dictionary, and processing the M clear pixels of the grid, corresponding grids of the face image to be processed are replaced. And repeating the above operations to all grids of the face image to be processed can realize deblurring of the face image to be processed.

In an alternative implementation of this embodiment, Step S25 specifically comprises the following steps:

Step S251, acquiring clear pixels of the grids.

In this embodiment, the pixel of the grids in the second grid dictionary may be obtained by summing up and averaging all pixels of each grid; moreover, because of grid division after alignment onto the face mask, the face image to be processed, the first grid dictionary and the second grid dictionary have the same number of divided grids, which are indicated as N; each grid has the same number of pixels, allowing the use of a pixel vector composed of all pixels in the grid to indicate the pixel of the grid, that is, the pixel of the grids of the second grid dictionary is annotated as \vec{y}ⱼ, wherein j is a j^{th} grid in the second grid dictionary, and j=1 to N.

In an alternative implementation of this embodiment, the pixel of the grids of the second grid dictionary is indicated by a pixel vector composed of all pixels in the grid, i.e., \vec{y}ⱼ.

Step S252, processing the grids of the face image to be processed, so that the pixel of each grid of the face image to be processed is the sum of the pixels of the plurality of clear grids.

In this embodiment, the sum of the pixels of M clear grids corresponding to each grid of the face image to be processed is calculated, and corresponding pixel of the grids of the face image to be processed is replaced with the sum of the pixels of the M clear grids. Therefore, sequentially repeating the above operations to all grids of the face image to be processed can realize deblurring of the face image to be processed.

### Embodiment 3

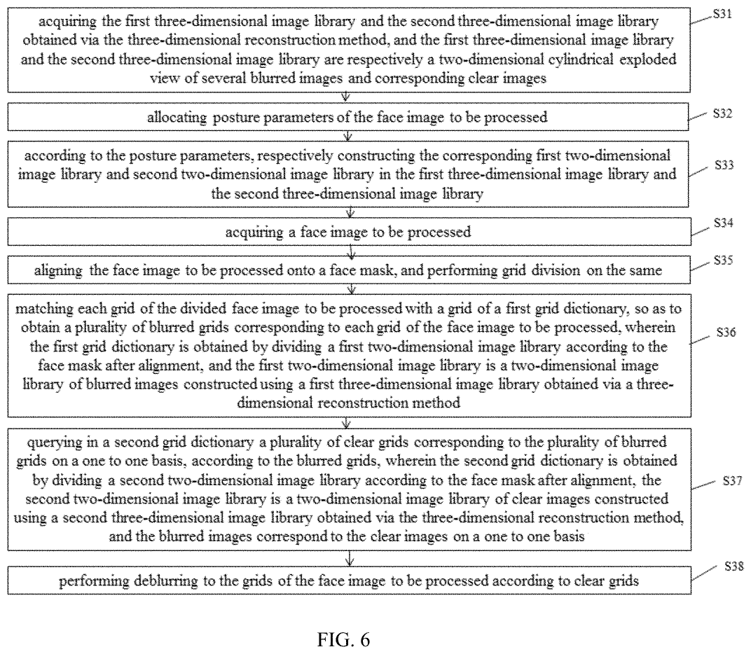

This embodiment provides a face deblurring method used in a face deblurring device. As shown in FIG. 6, the face deblurring method comprises the following steps:

Step S31, acquiring the first three-dimensional image library and the second three-dimensional image library obtained via the three-dimensional reconstruction method, and the first three-dimensional image library and the second three-dimensional image library are respectively a two-dimensional cylindrical exploded view of several blurred images and corresponding clear images.

Processing the several blurred images and a corresponding clear image respectively using the three-dimensional reconstruction method of the present invention, so as to obtain a two-dimensional cylindrical exploded view of the several blurred images and the corresponding clear image, i.e., the first three-dimensional image library and the second three-dimensional image library.

Step S32, allocating posture parameters of the face image to be processed.

In this embodiment, the posture parameters are angles (θₓ, θ_{y}, θ_{z}) of the face image to be processed in three-dimensional space; wherein, θₓ is an offset angle of the face image to be processed in an x direction, θ_{y} is an offset angle of the face image to be processed in a y direction, and θ_{z} is an offset angle of the face image to be processed in a z direction.

Step S33, according to the posture parameters, respectively constructing the corresponding first two-dimensional image library and second two-dimensional image library in the first three-dimensional image library and the second three-dimensional image library.

In this embodiment, a user sets corresponding posture parameters according to the angle of the face image to be processed in the three-dimensional space, so as to acquire the first two-dimensional image library under the corresponding posture parameters from the first three-dimensional image library, and to acquire the second two-dimensional image library under the corresponding posture parameters from the second three-dimensional image library.

Step S34, acquiring a face image to be processed. The step is the same as Step S21 in embodiment 2, and will not be repeated.

Step S35, aligning the face image to be processed onto a face mask, and performing grid division on the same. The step is the same as Step S22 in embodiment 2, and will not be repeated.

Step S36, matching each grid of the divided face image to be processed with a grid of a first grid dictionary, so as to obtain a plurality of blurred grids corresponding to each grid of the face image to be processed, wherein the first grid dictionary is obtained by dividing a first two-dimensional image library according to the face mask after alignment, and the first two-dimensional image library is a two-dimensional image library of blurred images constructed using a first three-dimensional image library obtained via a three-dimensional reconstruction method. The step is the same as Step S23 in embodiment 2, and will not be repeated.

Step S37, querying in a second grid dictionary a plurality of clear grids corresponding to the plurality of blurred grids on a one to one basis, according to the blurred grids, wherein the second grid dictionary is obtained by dividing a second two-dimensional image library according to the face mask after alignment, the second two-dimensional image library is a two-dimensional image library of clear images constructed using a second three-dimensional image library obtained via the three-dimensional reconstruction method, and the blurred images correspond to the clear images on a one to one basis. The step is the same as Step S24 in embodiment 2, and will not be repeated.

Step S38, performing deblurring to the grids of the face image to be processed according to clear grids. The step is the same as Step S25 in embodiment 2, and will not be repeated.

The face deblurring method provided by this embodiment can allow a user to set the posture parameters of a face image to be processed in the space, and to acquire a two-dimensional image dictionary under corresponding posture parameters in a histogram dictionary, and thus perform face deblurring in a video surveillance scene.

### Embodiment 4

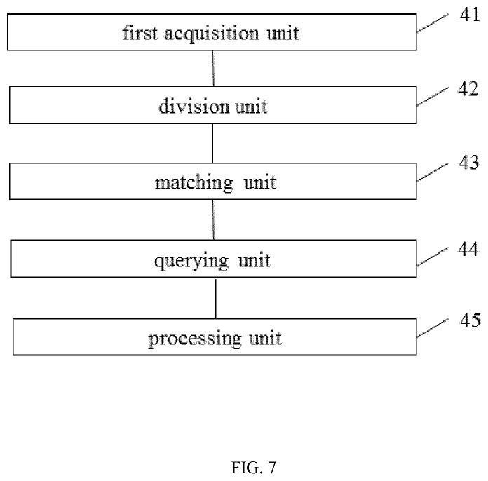

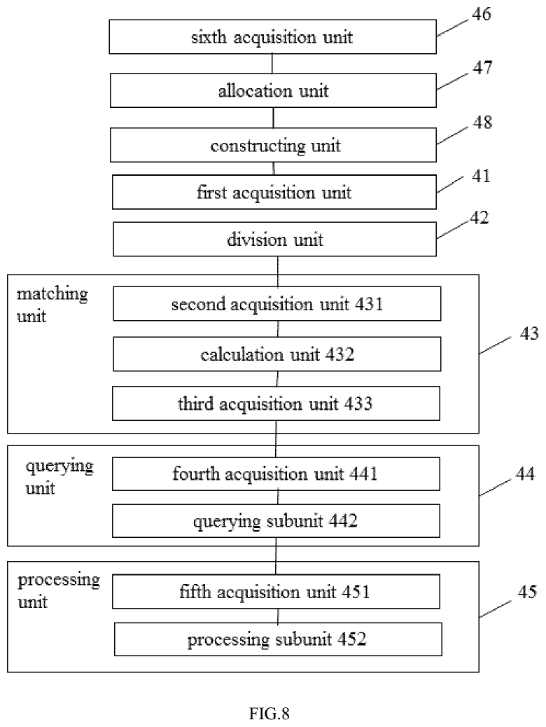

This embodiment provides a face deblurring device for executing the face deblurring method in embodiments 1 to 3 of the present invention. As shown in FIG. 7, the face deblurring device comprises:

a first acquisition unit 41, for acquiring a face image to be processed;

a division unit 42, for aligning the face image to be processed onto a face mask, and performing grid division on the same;

a matching unit 43, for matching each grid of the divided face image to be processed with a grid of a first grid dictionary, so as to obtain a plurality of blurred grids corresponding to each grid of the face image to be processed, wherein the first grid dictionary is obtained by dividing a first two-dimensional image library according to the face mask after alignment, and the first two-dimensional image library is a two-dimensional image library of blurred images constructed using a first three-dimensional image library obtained via a three-dimensional reconstruction method.

a querying unit 44, for querying in a second grid dictionary a plurality of clear grids corresponding to the plurality of blurred grids on a one to one basis, according to the blurred grids, wherein the second grid dictionary is obtained by dividing a second two-dimensional image library according to the face mask after alignment, the second two-dimensional image library is a two-dimensional image library of clear images constructed using a second three-dimensional image library obtained via the three-dimensional reconstruction method, and the blurred images correspond to the clear images on a one to one basis; and

a processing unit 45, for generating a clear image of the face image to be processed according to the queried clear grids.

The face deblurring device provided by this embodiment is able to process face images with different postures with good face deblurring effect.

In an alternative implementation of this embodiment, as shown in FIG. 8, the matching unit 43 comprises:

a second acquisition unit 431, for acquiring pixels of each grid of the face image to be processed and each grid of the first grid dictionary, respectively;

a calculation unit 432, for calculating an Euclidean distance of degree of similarity of pixels between each grid of the face image to be processed and each grid of the first grid dictionary, respectively, according to the acquired pixels; and

a third acquisition unit 433, for acquiring M blurred grids matched with each grid of the face image to be processed according to the calculated Euclidean distance.

In an alternative implementation of this embodiment, as shown in FIG. 8, the querying unit 44 comprises:

a fourth acquisition unit 441, for acquiring coordinates of the blurred grids on the face mask; and

a querying subunit 442, for querying clear grids corresponding to the blurred grids in the second grid dictionary according to the coordinates.

In an alternative implementation of this embodiment, as shown in FIG. 8, the processing unit 45 comprises:

a fifth acquisition unit 451, for acquiring pixels of the clear grids.

a processing subunit 452, for processing grids of the face image to be processed, so that the pixels of each grid of the face image to be processed is a sum of the pixels of the plurality of clear grids.

In an alternative implementation of this embodiment, as shown in FIG. 8, the face deblurring device further comprises:

a sixth acquisition unit 46, for acquiring the first three-dimensional image library and the second three-dimensional image library obtained via the three-dimensional reconstruction method, and the first three-dimensional image library and the second three-dimensional image library are respectively a two-dimensional cylindrical exploded view of several blurred images and corresponding clear images;

an allocation unit 47, for allocating posture parameters of the face image to be processed; and

a constructing unit 48, for constructing the corresponding first two-dimensional image library and second two-dimensional image library in the first three-dimensional image library and the second three-dimensional image library respectively, according to the posture parameters.

### Embodiment 5

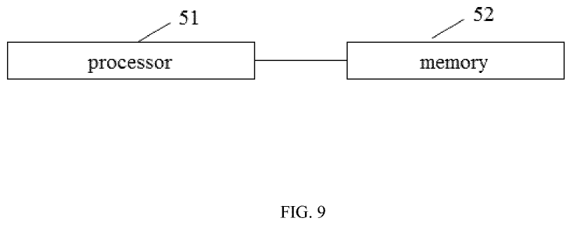

FIG. 9 is a hardware structural diagram for an image processing device provided by an embodiment of the present invention, as shown in FIG. 9, the device comprises one or more processors 51 and memory 52, and a processor 51 is taken as an example in FIG. 9.

The image processing device may further comprise: an image display (not shown), for displaying processing results of the image in comparison. The processor 51, memory 52 and image display may be connected by a bus or other means, and as an example, are connected by a bus in FIG. 9.

The processor 51 may be a central processing unit (Central Processing Unit, CPU), and may also be other general-purpose processor, digital signal processor (Digital Signal Processor, DSP), application specific integrated circuit (Application Specific Integrated Circuit, ASIC), field-programmable gate array (Field-Programmable Gate Array, FPGA) or other programmable logic device, discrete gate or transistor logic device, discrete hardware components and other chips, or a combination of the above various types of chips. The general-purpose processor can be a microprocessor, or any conventional processors.

The memory 52 is a non-transient computer readable storage medium, which can be used for storing non-transitory software programs, non-transitory computer executable program and modules, such as program instructions/modules corresponding to face deblurring method in the embodiments of the present invention. By running the non-transit software programs, instructions and modules stored in the memory 52, the processor 51 performs various functions and applications and data processing of a server, i.e., implements the face deblurring method in the above embodiments.

The memory 52 can comprise a program storage area and a data storage area, wherein, the program storage area can store an operating system, and at least one application program needed by the functions. The data storage area can store the data created by the use of the face deblurring device. In addition, the memory 52 may comprise high-speed random access memory, and can also comprise non-transitory memory, for example, at least one disk storage device, flash device, or other non-transitory solid storage devices. In some embodiments, the memory 52 optionally comprises memory configured remotely relative to the processor 51, and the remote memory can be linked with the face deblurring device through networks. Examples of the above networks include but are not limited to the internet, corporate intranet, local area network, mobile communication network and combinations thereof.

The one or more modules are stored in the memory 52, and when executed by the one or more processor 51, execute the face deblurring method in any of embodiment 1 to embodiment 3.

The above products can execute the method provided in the embodiments of the present invention, and thus have functional modules and beneficial effects corresponding to the method to be executed. And please refer to relevant description of the embodiment shown in FIG. 1 for those technical details not specifically described in this embodiment.

### Embodiment 6

The embodiment of the present invention further provides a non-transitory computer storage medium storing computer executable instructions which may execute the face image deblurring method in any one of embodiments 1 to 3. The storage medium may be a disk, CD, read-only memory (Read-Only Memory, ROM), random access memory (Random Access Memory, RAM), flash memory (Flash Memory), hard disk drive (Hard Disk Drive, HDD), hard disk or solid-state drive (Solid-State Drive, SSD), etc.; the storage medium can also comprise a combination of the above types of memory.

Those skilled in the art can understand that, all or part of the process for implementing the method in the above embodiments can be completed by hardware under instructions from a computer program, and the program can be stored in a computer readable storage medium. When executed, the program may comprise the process in the embodiments of the method. The storage medium can be a disk, a compact disk, a read only memory (ROM) or a random access memory (RAM).

Although the embodiments of the invention are described in conjunction with drawings, those skilled in the art can make various modifications and variations without departing from the spirit and scope of the present invention. All such modifications and variations fall into the scope defined by the attached claims.

What is claimed is:

1. A face deblurring method, characterized in comprising the following steps:
acquiring a face image to be processed;
aligning the face image to be processed onto a face mask, and performing grid division on the same;
matching each grid of the divided face image to be processed with a grid of a first grid dictionary, so as to obtain a plurality of blurred grids corresponding to each grid of the face image to be processed, wherein the first grid dictionary is obtained by dividing a first two-dimensional image library according to the face mask after alignment, and the first two-dimensional image library is a two-dimensional image library of blurred images constructed using a first three-dimensional image library obtained via a three-dimensional reconstruction method;
querying in a second grid dictionary a plurality of clear grids corresponding to the plurality of blurred grids on a one to one basis, according to the blurred grids, wherein the second grid dictionary is obtained by dividing a second two-dimensional image library according to the face mask after alignment, the second two-dimensional image library is a two-dimensional image library of clear images constructed using a second three-dimensional image library obtained via the three-dimensional reconstruction method, and the blurred images correspond to the clear images on a one to one basis; and
generating a clear image of the face image to be processed according to the queried clear grids.

2. The face deblurring method according to claim 1, characterized in that matching each grid of the divided face image to be processed with a grid of a first grid dictionary so as to obtain a plurality of blurred grids corresponding to each grid of the face image to be processed comprises the following steps:
acquiring pixels of each grid of the face image to be processed and each grid of the first grid dictionary, respectively;
calculating a Euclidean distance of pixels between each grid of the face image to be processed and each grid of the first grid dictionary, respectively, according to the acquired pixels; and
acquiring M blurred grids matched with each grid of the face image to be processed according to the calculated Euclidean distance.

3. The face deblurring method according to claim 1, characterized in that querying in a second grid dictionary a plurality of clear grids corresponding to the plurality of blurred grids on a one to one basis, according to the blurred grids, comprises the following steps:
acquiring coordinates of the blurred grids on the face mask; and
querying the clear grids corresponding with the blurred grids in the second grid dictionary according to the coordinates.

4. The face deblurring method according to claim 1, characterized in that deblurring grids of the face image to be processed according to the clear grids comprises the following steps:
acquiring pixels of the clear grids; and
processing grids of the face image to be processed, so as to cause the pixels of each grid of the face image to be processed to be the sum of the pixels of the plurality of clear grids.

5. The face deblurring method according to claim 1, characterized in comprising the following steps before acquiring the face image to be processed:
acquiring the first three-dimensional image library and the second three-dimensional image library obtained via the three-dimensional reconstruction method, wherein, the first three-dimensional image library and the second three-dimensional image library are respectively a two-dimensional cylindrical exploded view of several blurred images and corresponding clear images;
allocating posture parameters of the face image to be processed; and
constructing the corresponding first two-dimensional image library and second two-dimensional image library in the first three-dimensional image library and the second three-dimensional image library respectively, according to the posture parameters.

6. The face deblurring method according to claim 5, characterized in that the posture parameters are angles (θₓ, θ_{y}, θ_{z}) of the face image to be processed in three-dimensional space;
wherein, θₓ is an offset angle of the face image to be processed in an x direction, θ_{y} is an offset angle of the face image to be processed in a y direction, and θ_{z} is an offset angle of the face image to be processed in a z direction.

7. The face deblurring method according to claim 2, characterized in that querying in a second grid dictionary a plurality of clear grids corresponding to the plurality of blurred grids on a one to one basis, according to the blurred grids, comprises the following steps:
acquiring coordinates of the blurred grids on the face mask; and
querying the clear grids corresponding with the blurred grids in the second grid dictionary according to the coordinates.

8. The face deblurring method according to claim 2, characterized in that deblurring grids of the face image to be processed according to the clear grids comprises the following steps:
acquiring pixels of the clear grids; and
processing grids of the face image to be processed, so as to cause the pixels of each grid of the face image to be processed to be the sum of the pixels of the plurality of clear grids.

9. The face deblurring method according to claim 3, characterized in that deblurring grids of the face image to be processed according to the clear grids comprises the following steps:
acquiring pixels of the clear grids; and
processing grids of the face image to be processed, so as to cause the pixels of each grid of the face image to be processed to be the sum of the pixels of the plurality of clear grids.

10. The face deblurring method according to claim 2, characterized in comprising the following steps before acquiring the face image to be processed:
acquiring the first three-dimensional image library and the second three-dimensional image library obtained via the three-dimensional reconstruction method, wherein, the first three-dimensional image library and the second three-dimensional image library are respectively a two-dimensional cylindrical exploded view of several blurred images and corresponding clear images;
allocating posture parameters of the face image to be processed; and
constructing the corresponding first two-dimensional image library and second two-dimensional image library in the first three-dimensional image library and the second three-dimensional image library respectively, according to the posture parameters.

11. The face deblurring method according to claim 3, characterized in comprising the following steps before acquiring the face image to be processed:
acquiring the first three-dimensional image library and the second three-dimensional image library obtained via the three-dimensional reconstruction method, wherein, the first three-dimensional image library and the second three-dimensional image library are respectively a two-dimensional cylindrical exploded view of several blurred images and corresponding clear images;
allocating posture parameters of the face image to be processed; and
constructing the corresponding first two-dimensional image library and second two-dimensional image library in the first three-dimensional image library and the second three-dimensional image library respectively, according to the posture parameters.

12. The face deblurring method according to claim 4, characterized in comprising the following steps before acquiring the face image to be processed:
acquiring the first three-dimensional image library and the second three-dimensional image library obtained via the three-dimensional reconstruction method, wherein, the first three-dimensional image library and the second three-dimensional image library are respectively a two-dimensional cylindrical exploded view of several blurred images and corresponding clear images;
allocating posture parameters of the face image to be processed; and
constructing the corresponding first two-dimensional image library and second two-dimensional image library in the first three-dimensional image library and the second three-dimensional image library respectively, according to the posture parameters.

13. A face deblurring device, characterized in comprising:
a first acquisition unit, for acquiring a face image to be processed;
a division unit, for aligning the face image to be processed onto a face mask, and performing grid division on the same;
a matching unit, for matching each grid of the divided face image to be processed with a grid of a first grid dictionary, so as to obtain a plurality of blurred grids corresponding to each grid of the face image to be processed, wherein the first grid dictionary is obtained by dividing a first two-dimensional image library according to the face mask after alignment, and the first two-dimensional image library is a two-dimensional image library of blurred images constructed using a first three-dimensional image library obtained via a three-dimensional reconstruction method;
a querying unit, for querying in a second grid dictionary a plurality of clear grids corresponding to the plurality of blurred grids on a one to one basis, according to the blurred grids, wherein the second grid dictionary is obtained by dividing a second two-dimensional image library according to the face mask after alignment, the second two-dimensional image library is a two-dimensional image library of clear images constructed using a second three-dimensional image library obtained via the three-dimensional reconstruction method, and the blurred images correspond to the clear images on a one to one basis; and
a processing unit, for generating a clear image of the face image to be processed according to the queried clear grids.

14. The face deblurring device according to claim 13, characterized in that the matching unit comprises:
a second acquisition unit, for acquiring pixels of each grid of the face image to be processed and each grid of the first grid dictionary, respectively;
a calculation unit, for calculating a Euclidean distance of pixels between each grid of the face image to be processed and each grid of the first grid dictionary, respectively, according to the acquired pixels; and
a third acquisition unit, for acquiring M blurred grids matched with each grid of the face image to be processed according to the calculated Euclidean distance.

15. An image processing device, characterized in comprising at least one processor; and
memory in communication connection with the at least one processor;
wherein, the memory stores instructions executable by the one processor, and the instructions are executed by the at least one processor, so that the at least one processor executes the face deblurring method in claim 1.
